(19) United States
(12) Patent Application Publication
(10) Pub. No.: US 2012/0023106 A1
(43) Pub. Date: Jan. 26, 2012

(54) MAP INFORMATION PROCESSING APPARATUS, MAP INFORMATION PROCESSING METHOD, MAP INFORMATION PROCESSING PROGRAM, AND RECORDING MEDIUM

(75) Inventors: Tetsuya Kurata, Tokyo (JP); Wazo Fukuhara, Foster City, CA (US)

(73) Assignees: INCREMENT P CORPORATION, KANAGAWA (JP); PIONEER CORPORATION, KANAGAWA (JP)

(21) Appl. No.: 13/201,250

(22) PCT Filed: Feb. 13, 2009
(86) PCT No.: PCT/JP2009/052413

§ 371 Date: Sep. 30, 2011

(51) Int. Cl. G06F 17/30

(52) U.S. Cl. 707/743; 707/E17.018

(57) ABSTRACT

There are provided a map information processing apparatus, a map information processing method, a map information processing program and a recording medium, which provide house-contour data with valuable information such as address information and the like in an effective manner and with a high degree of accuracy, while remarkably minimizing time and cost as required.

### TECHNICAL FIELD

The present invention relates to a map information processing apparatus that processes map information to be provided to a user, and the other.

### BACKGROUND OF THE INVENTION

There has recently been known all over the world a map information supplying system through which map data are supplied from a map information web site (a server) on a network of Internet or the like to a client's terminal. Map data on Japan supplied from map information web sites in Japan is well-organized in comparison with foreign countries. The map data on Japan include for example house-contour data. Such house-contour data are associated with name data, classification data, adjacent road data, address data, etc., as disclosed in Patent Document 1.
Patent Document 1: Japanese Patent Provisional Publication No. H09-152831

### DISCLOSURE OF THE INVENTION

### Subject to be Solved by the Invention

There is known map data provided from a map information web site in foreign countries, for example, map data of the United States of America provided from a map information web site therein, in which map data are included. However, valuable information including address data (address information) is not associated with the above-mentioned house-contour data in a different manner from the map data of Japan as described above. Therefore, there is no sufficient information, which is to be supplied to a user, and a specific house-contour cannot be retrieved by inputting an address. Hence, there is a need to associate valuable information including address information and the like with the house-contour data in such a map data as described above.

However, associating the address information and the like with each of the house-contour data in such a map data requires a great deal of time and cost, thus causing a problem. Especially, such a problem will occur notably in the map of a country such as the United States of America having a vast area of land.

The present invention has therefore a problem to solve the above-described problems as one of problems to be solved. An exemplary object of the present invention is to provide a map information processing apparatus, a map information processing method, a map information processing program and a recording medium, which permit to provide the house-contour data with valuable information such as address information and the like in an effective manner, while remarkably minimizing time and cost as required.

### Means to Solve the Subject

In order to attain the aforementioned object, the map information processing apparatus claimed in claim 1 comprises: a reading unit that reads first map data comprising road link information including house number range information indicative of a range of a house number and second map data comprising contour-coordinate information indicative of a group of coordinates by which planar contours of buildings or parcels of land are represented; a selection unit that selects the contour-coordinate information corresponding to a single building or parcel of land of the buildings or parcels of land; a road link specifying unit that specifies, based on the contour-coordinate information as selected, a nearest road link to the building or parcel of land corresponding to said contour-coordinate information; a house number range information acquiring unit that acquires the house number range information of said road link information corresponding to the road link as specified; a house number calculating unit that calculates, based on the house number range information as acquired, the house number of a point at an intersection of a perpendicular line drawn from a predetermined point to said road link as specified, with said road link, said predetermined point being placed on an outer edge of the planar contour of said building or parcel of land, presented by the contour-coordinate information as selected, or placed within an inside of said planar contour; and a house number determining unit that determines, based on the house number as calculated, the house number, which is to be assigned to said contour-coordinate information as selected.

The map information processing method claimed in claim 4 comprises the steps of: reading first map data comprising road link information including house number range information indicative of a range of a house number and second map data comprising contour-coordinate information indicative of a group of coordinates by which planar contours of buildings or parcels of land are represented; selecting the contour-coordinate information corresponding to a single building or parcel of land of the buildings or parcels of land; specifying step of specifying, based on the contour-coordinate information as selected, a nearest road link to the building or parcel of land corresponding to said contour-coordinate information; acquiring the house number range information of said road link information corresponding to the road link as specified; calculating, based on the house number range information as acquired, the house number of a point at an intersection of a perpendicular line drawn from a predetermined point to said road link as specified, with said road link, said predetermined point being placed on an outer edge of the planar contour of said building or parcel of land, presented by the contour-coordinate information as selected, or placed within an inside of said planar contour; and determining, based on the house number as calculated, the house number, which is to be assigned to said contour-coordinate information as selected.

The map information processing program claimed in claim 5 causes a computer to function as: a reading unit that reads first map data comprising road link information including house number range information indicative of a range of a house number and second map data comprising contour-coordinate information indicative of a group of coordinates by which planar contours of buildings or parcels of land are represented; a selection unit that selects the contour-coordinate information corresponding to a single building or parcel of land of the buildings or parcels of land; a road link specifying unit that specifies, based on the contour-coordinate information as selected, a nearest road link to the building or parcel of land corresponding to said contour-coordinate information; a house number range information acquiring unit that acquires the house number range information of said road link information corresponding to the road link as specified; a house number calculating unit that calculates, based on the house number range information as acquired, the house number of a point at an intersection of a perpendicular line drawn from a predetermined point to said road link as specified, with said road link, said predetermined point being placed on an outer edge of the planar contour of said building or parcel of land, presented by the contour-coordinate information as selected, or placed within an inside of said planar contour; and a house number determining unit that determines, based on the house number as calculated, the house number, which is to be assigned to said contour-coordinate information as selected.

### BRIEF DESCRIPTION OF THE DRAWINGS

FIG. 1 is a view illustrating a schematic configuration example of a map information processing apparatus according to the embodiment of the present invention;

FIG. 2 is a view illustrating an image in which examples of a building, a parcel of land and a road are displayed;

FIG. 3 (A) is a view illustrating an example of a data structure of a contour-coordinate information, and FIG. 3 (B) is a view illustrating an example of the house-contour;

FIG. 4 is a view illustrating an image in which a road link and a POI are displayed;

FIG. 5 is a flowchart showing an example of a map information processing by an arithmetic processing section 2;

FIG. 6 is a view illustrating an image to facilitate understanding of steps of the map information processing;

FIG. 7 is a view illustrating an image to facilitate understanding of steps of the map information processing; and

FIG. 8 is a view illustrating an image to facilitate understanding of steps of the map information processing.

### EXPLANATION OF THE REFERENCE NUMERALS

1 storage section
2 arithmetic processing section
2a map data reading section
2b processing object selecting section
2c road link specifying section
2d house number range-acquiring section
2e POI house number acquiring section
2f house number calculating section
2g house number determining section
2h association information generating section
3 operation section
4 display section
S map information processing apparatus

### BEST MODE FOR CARRYING OUT THE INVENTION

Now, embodiments of the present invention will be described below with reference to the accompanying drawings.

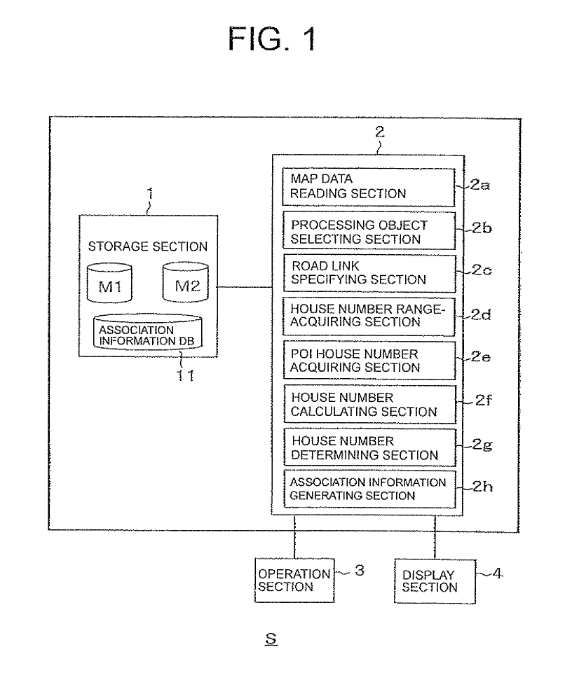

First, description will be given below of a structure and function of the map information processing apparatus according to the embodiment of the present invention, with reference to FIG. 1, etc.

FIG. 1 is a view illustrating a schematic configuration example of the map information processing apparatus according to the embodiment of the present invention.

As shown in FIG. 1, the map information processing apparatus S includes a storage section 1 having a hard disc drive, etc., an arithmetic processing section 2 having a CPU, a RAM, a ROM, etc., an operation section 3 having an mouse and a keyboard, etc., that receive instruction from a user, and a display section 4 having a display screen.

The storage section 1 stores a first map data (hereinafter referred to as the “map data M1”) and a second map data (hereinafter referred to as the “map data M2”). In addition, the storage section 1 creates association information database 11 on which association information is registered.

Now, the map data M1 will be described below.

The map data M1 includes road link data (an example of road link information) and POI (Point of interest) data (an example of POI information).

The road link data include data having a road type, a link type, a regulation, a street name, a house number range, etc.; and a road link ID.

The road link data are set for each of the road links and the respective road link data are identified by a unique road link ID. The road links are elements of which a road indication is composed and the respective road link branches off for example at a fork in the road (a connection point). The road link data include coordinate information of two nodes in the road link. The coordinate information may be represented for example by latitude and longitude.

The house number range is information indicative of a range of the house number, which is to be assigned to a building. The house number may be used as one of the address information.

The POI data include text data having a name of a POI such as facilities (for example, a restaurant, a shopping mall, a gas station, etc.), a genre (a category), a brand information, a street name, a house number and the other; and POI coordinate information indicative of coordinates of the POI by which the position of the POI is represented as a dot; and an ID of the POI.

The POI data are set for each of the POIs, and the respective POI data are identified by a unique ID of the POI.

The POI data are associated with the road link data. For example, the POI data for a certain POI are associated with the road link data for a road link, which is placed in the vicinity of this POI. Such an association is made based on the respective ID or street name.

The coordinates of a POI as indicated by the POI coordinate information may be represented for example by latitude and longitude. The coordinates of the POI range from the high-accurate to the less-accurate.

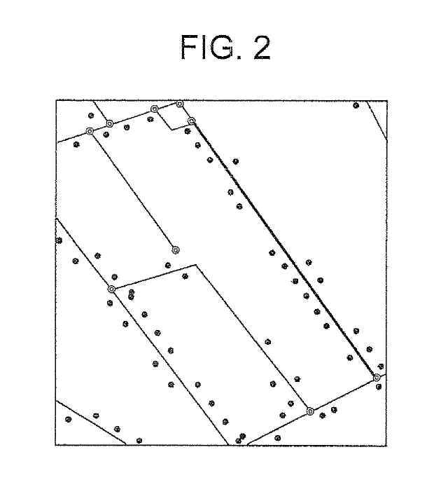

FIG. 2 is a view illustrating an image in which a road link and a POI are displayed.

In the example shown in FIG. 2, black dots denote a mark indicative of the POI, and solid lines denote the road link.

Now, the map data M2 will be described.

The map data M2 include contour data by which a planar contour of a building, a parcel of land, a green space, a water system, a road width and the like may be represented.

The contour data include contour-coordinate information (corresponding to the above-described house-contour data) indicative of a group of coordinates by which a planar contour of a building or a parcel of land (hereinafter referred to as the “house-contour”) is represented. The respective coordinates included in the group of coordinates indicated by the contour coordinate information may be represented for example by latitude and longitude. The group of coordinates represented by this contour coordinate information is a group of coordinates by which the planer contour is represented based on the planer contour of the building, which actually exists or once existed, or the parcel of land, which is actually demarcated or was once demarcated. The above-mentioned group of coordinates is determined by reliable data such as field survey data, aerial photograph data, etc., thus being extremely accurate.

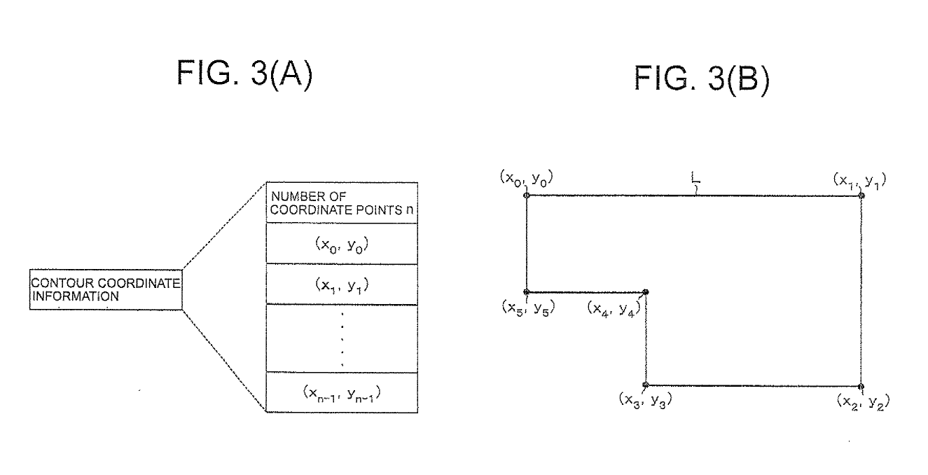

FIG. 3(A) is a view illustrating an example of a data structure of contour coordinate information and FIG. 3(B) is a view illustrating an example of the house-contour. As shown in FIG. 3(A), the contour-coordinate information includes the number of coordinate points “n” in the group of coordinates and the respective coordinates (x₀, y₀), (x₁, y₁), . . . , (xₙ₋₁, Yₙ₋₁) included in the group of coordinates. In case where the house-contour has for example a hexagonal shape as shown in FIG. 3(B), the contour-coordinate information includes the number of coordinates points of “6” and the coordinates of the respective vertexes (x₀, y₀)˜(x₅, y₅). By connecting the vertexes with a line in an address order in a memory in which the respective coordinates have been stored, the contour “L” of the house may be represented as shown in FIG. 3. There may be obtained, through a calculation, the respective coordinates included in the group of coordinates that are placed on the contour “L” of the house, and the respective coordinates included in the group of coordinates that are placed within the inside of the contour “L” of the house.

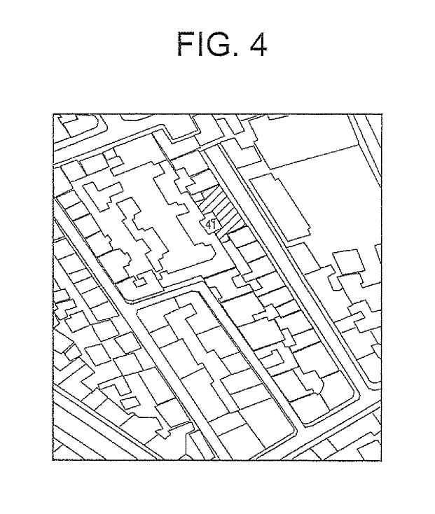

FIG. 4 is a view illustrating an image in which examples of a building, a parcel of land and a road are displayed. In an example as shown in FIG. 4, a plurality of house-contours (e.g., “41” in the figure) is shown. A unique house contour ID is assigned to the contour-coordinate information corresponding to the respective house contour. Reading programs (including the map information processing program of the present invention) stored in the ROM, etc. by the CPU to execute them causes the arithmetic processing section 2 to function as a map data reading section (an example of the reading unit) 2a, a processing object selecting section (an example of the selection unit) 2b, a road link specifying section (an example of the road link specifying unit) 2c, a house number range-acquiring section (an example of the house number range information acquiring unit) 2d, a POI house number acquiring section (an example of the POI house number acquiring unit) 2e, a house number calculating section (an example of the house number calculating unit) 2f, a house number determining section (an example of the house number determining unit) 2g, an association information generating section (an example of the association information generating unit) 2h and the like, so as to carry out a map information processing. Such a map information processing is not always carried out, while displaying the map on the display screen. However, there may be adopted a configuration in which instructions given by an operator through the operation section 3 may be received, while displaying the map on the display screen, where appropriate.

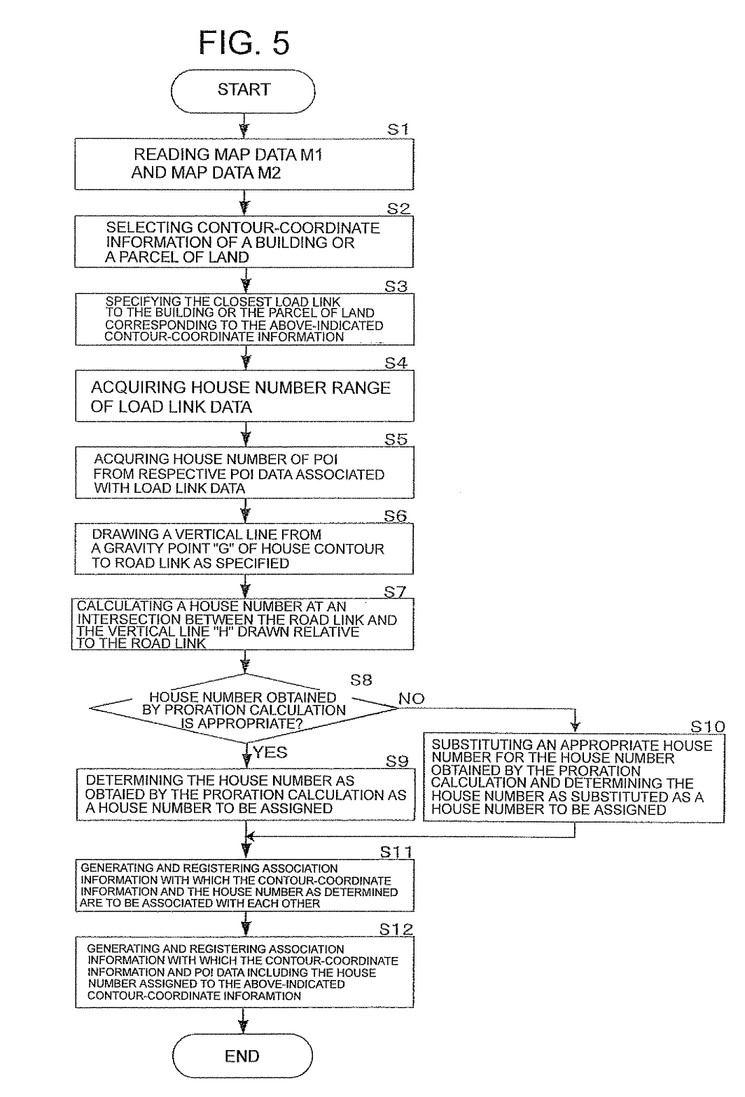

Now, the map information processing by the arithmetic processing section 2 will described with reference to FIG. 5.

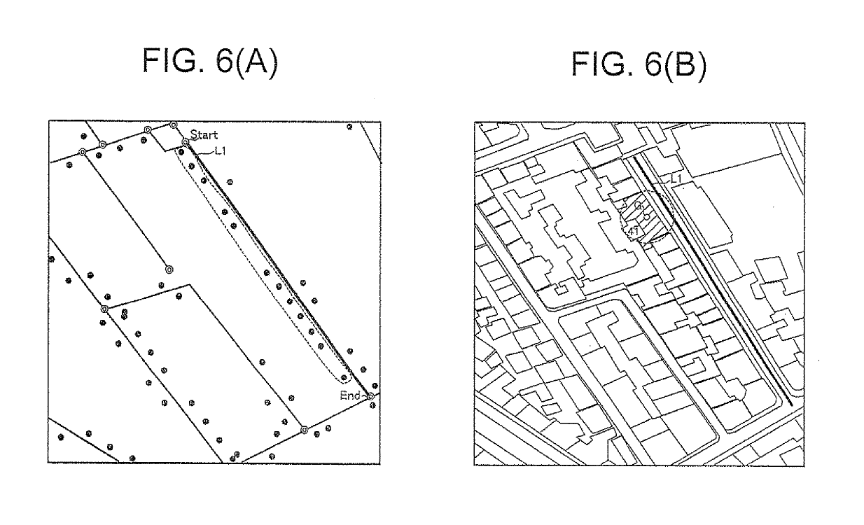

FIG. 5 is a flowchart showing an example of the map information processing by the arithmetic processing section 2. FIGS. 6 to 8 are views illustrating images to facilitate understanding of steps of the map information processing.

The processing as shown in FIG. 5 starts with for example a start instruction given by an operator through the operation section 3. When the processing starts, the map data reading section 2a reads the map data M1 and the map data M2 from the storage section 1 (Step S1) to carry out the processing under the same environment.

Then, the processing object selecting section 2b selects the contour-coordinate information of a single building or a single parcel of land to be processed, of the plurality of buildings or parcels of land (Step S2). There is an assumption that the house contour 41 as shown in FIG. 6 is a house contour represented by the contour-coordinate information as selected.

The road link specifying section 2c specifies, based on the above-described contour-coordinate information as selected, the nearest road link to the building or parcel of land corresponding to the contour-coordinate information (Step S3). The nearest road link may be specified by for example conducting a space retrieval from a barycentric position of the house contour represented by the contour-coordinate information as selected (for example, the space retrieval with a specified range, setting the coordinates of the barycentric position of the house contour as the center of the range). The road link may be specified based on the coordinates included in the above-mentioned range by conducting for example the space retrieval, i.e., the retrieval with the specified range. There is specified the nearest road link L1 to the house contour 41 as shown for example in FIG. 6(B).

Then, the house number range-acquiring section 2d extracts the road link data corresponding to the above-described road link as specified and acquires the house number range (e.g., 2 to 34) of the road link data as extracted (Step S4). Here, the road link data extracted correspondingly to the above-described road link as specified are the road link data, which include coordinate information on the vicinity at the opposite ends of the road link as specified in Step S3. For example, there are extracted the road link data that include the respective coordinates represented by the coordinate information of the road link as specified or the respective coordinates within a predetermined range a center of which is placed on the respective coordinates.

Then, the POI house number acquiring section 2e acquires the house number of the POI from the respective POI data, which have been associated with the road link data corresponding to the above-described road link as specified (Step S5). The POI is placed on the opposite sides of the road link. For example, the house number of the POI placed on the left-hand side of the road link is set as an even number and the house number of the POI placed on the right-hand side of the road link is set as an odd number. In the processing of Step S5, there is acquired the house number of the POI placed on the side of the house contour as represented by the above-described contour-coordinate information as selected, of the road link as specified. There is acquired the house number HN of the POI (the POI encompassed by broken lines) placed on the right-hand side relative to the direction of from “Start” to “End” of the road link in the example as shown for example in FIG. 6(A). This permits acquisition of sequence (e.g., 2, 4, 6, 10, 12 - - - ) of the house number HN of the POI.

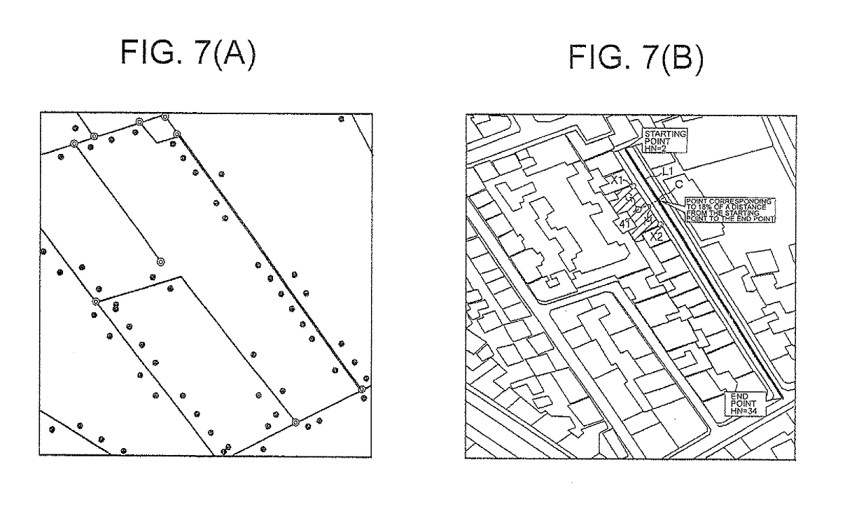

Then, the house number calculating section 2f causes a perpendicular line H to be drawn from the barycentric position G of the house contour represented by the contour-coordinate information as selected, to the road link as specified (Step S6), as shown for example in FIG. 7(B)). The above-mentioned perpendicular line H may be drawn from the other point on the outer edge of the planar contour of the house or within the inside of the planar contour thereof, than the barycentric position G of the house contour. As shown for example in FIG. 7(B), the perpendicular line may be drawn from the point X1 or the point X2 on the outer edge of the planar contour of the house to the road link.

Then, the house number calculating section 2f calculates, based on the above-described house number range as acquired, the house number HN of the point at an intersection between the perpendicular H line drawn relative to the road link as specified and the above-described road link (hereinafter referred to as the “intersection point”) (Step S7). More specifically, the house number can be calculated by prorating the house number range in accordance with a ratio of the distance between the start and the end of the above-described road link, relative to the whole distance between the start and the end of the road link (i.e., the distance between the nodes). In the example as shown in FIG. 7(B), the intersection point C is located at a point from 18% (of the above-described ratio) from the start of the road link L1. Consequently, the house number at this point may be calculated as “6” (with a number of decimals truncated) by prorating the house number range having the start house number of “2” and the end house number of “34”.

The house number determining section 2g determines the house number to be assigned to the contour-coordinate information as selected, based on the house number acquired through the above-described proration. The house number determining section 2g makes comparison in the sequence between the house number as acquired through the proration and the house number of the POI as acquired, and then judge as to whether or not the house number as acquired through the proration is proper (Step S8).

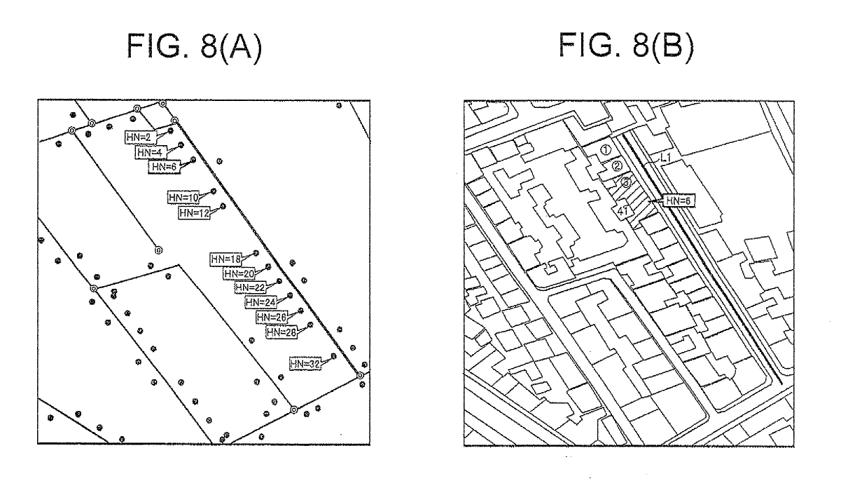

For example, the house contour 41 corresponding to the house number “6” acquired through the above-described proration is the third from the start of the road link L1 as shown in FIG. 8(B). The house number of the third of the sequence (2, 4, 6, 10, 12, - - - ) of the house number of the POI acquired is “6” as shown in FIG. 8(A). In this case, the both sides are coincident with each other. It is therefore judged that the house number as acquired through the above-described proration is proper. To the contrary, in case where the house contour 41 corresponding to the house number “6” acquired through the above-described proration is the second from the start of the road link L1, the house number of the second of the sequence (2, 4, 6, 10, 12, - - - ) of the house number of the POI acquired is “4” as shown in FIG. 8(A). In this case, the both sides are not coincident with each other. It is therefore judged that the house number as acquired through the above-described proration is not proper.

In case where the house number of the POI as acquired as shown in FIG. 8(A) is odd, the odd house number cannot exist. In this case, it is judged that the house number as acquired through the above-described proration is not proper.

In case where the house number as acquired through the proration is judged to be proper (YES in Step S8), the house number determining section 2g corrects, based on the house number as acquired through the proration and the house number of the POI as acquired, the house number as acquired through the proration for the proper house number, and then determines the corrected house number as the house number to be assigned to the contour-coordinate information as selected (Step S10). In case where the house contour 41 corresponding to the house number “6” acquired through the above-described proration is the second from the start of the road link L1, and the house number of the second of the sequence (2, 4, 6, 10, 12, - - - ) of the house number of the POI acquired is not “6”, but “4”, the house number “6” as acquired is corrected as “4”.

The association information generating section 2h generates association information with which an association between the contour-coordinate information as selected and the house number as determined is to be made, and then causes it to be registered in an association information database (Step S11). The association information includes for example the ID of the house-contour, the contour-coordinate information and the house number. The house number is assigned to the contour-coordinate information in this manner.

Then, the association information generating section 2h generates association information with which an association between the contour-coordinate information as selected and the POI data including the house number assigned to the above-mentioned contour-coordinate information is to be made, and then causes it to be registered in the association information database 11 (Step S12). This association information may include for example the ID of the house-contour and the ID of the POI.

The above-described processing is conducted for all the contour-ordinate information to be processed.

According to the embodiments of the present invention as described above, the map information processing apparatus S is configured to calculate, for the nearest road link to the house contour represented by the contour coordinate information as selected, the house number located at the intersection point between the road link and the perpendicular line drawn for example from the barycentric position of the house contour, through the proration based on the house number range of the road link data corresponding to the above-described road link, and then determine the house number to be assigned to the contour-coordinate information selected based on the house number as calculated. It is therefore possible to use two kinds of map data M1, M2 to assign, as the address information, the house number to the contour-coordinate information for representing the house contour in an effective manner, while remarkably minimizing time and cost as required, even in a region wherein the point coordinate information, which is indicative of the coordinates of the point by which the building or the parcel of land such as the POI included in the map data M1 is not accurate. Therefore, the specific house contour can be retrieved by inputting the address by the user, even in case where the map data are supplied to the client's terminal from a map information web site (server) in the United States of America.

In addition, there is a configuration that a comparison in sequence between the house number calculated through the proration based on the house number range included in the road link data and the house number of the POI included in the respective POI data as associated with the road link data is made to correct the house number. It is therefore possible to conduct a matching operation with the house number as currently assigned, thus increasing accuracy of the house number assigned to the contour coordinate information by which the house contour may be represented.

Further, there is a configuration that a registration may be made in association of the contour coordinate information with the POI data, with the use of the house number assigned to the contour coordinate information by which the house contour may be represented. It is therefore possible to provide useful information for the POI to the contour coordinate information by which the house contour may be represented. This enables the useful information to be provided together with the map data from for example the map information web site to the client's terminal.

The map data as created by the map information processing apparatus S according to the embodiments of the present invention may be utilized by the other apparatus such as a navigation apparatus or a search apparatus for the map, than the apparatus as described above.

1. A map information processing apparatus comprising:
a reading unit that reads first map data comprising road link information including house number range information indicative of a range of a house number and second map data comprising contour-coordinate information indicative of a group of coordinates by which planar contours of buildings or parcels of land are represented;
a selection unit that selects the contour-coordinate information corresponding to a single building or parcel of land of the buildings or parcels of land;
a road link specifying unit that specifies, based on the contour-coordinate information as selected, a nearest road link to the building or parcel of land corresponding to said contour-coordinate information;
a house number range information acquiring unit that acquires the house number range information of said road link information corresponding to the road link as specified;
a house number calculating unit that calculates, based on the house number range information as acquired, the house number of a point at an intersection of a perpendicular line drawn from a predetermined point to said road link as specified, with said road link, said predetermined point being placed on an outer edge of the planar contour of said building or parcel of land, presented by the contour-coordinate information as selected, or placed within an inside of said planar contour; and
a house number determining unit that determines, based on the house number as calculated, the house number, which is to be assigned to said contour-coordinate information as selected.

2. The map information processing apparatus as claimed in claim 1, wherein:
said first map data comprises POI (Point of Interest) information including a name of the POI and a house number;
said map information processing apparatus further comprises a POI house number acquiring unit which acquires the house number included in said POI information that is associated with said road link information corresponding to said road link as specified; and
said house number determining unit corrects, based on said house number as calculated and said house number as acquired, said house number as calculated, and determines the house number as corrected, as the house number to be assigned to said contour-coordinate information as selected.

3. The map information processing apparatus as claimed in claim 2, further comprises:
an association information generating unit that generates association information with which an association between said contour-coordinate information as selected and the POI information including said house number as determined is to be made.

4. A map information processing method comprising the steps of:
reading first map data comprising road link information including house number range information indicative of a range of a house number and second map data comprising contour-coordinate information indicative of a group of coordinates by which planar contours of buildings or parcels of land are represented;
selecting the contour-coordinate information corresponding to a single building or parcel of land of the buildings or parcels of land;
specifying step of specifying, based on the contour-coordinate information as selected, a nearest road link to the building or parcel of land corresponding to said contour-coordinate information;
acquiring the house number range information of said road link information corresponding to the road link as specified;
calculating, based on the house number range information as acquired, the house number of a point at an intersection of a perpendicular line drawn from a predetermined point to said road link as specified, with said road link, said predetermined point being placed on an outer edge of the planar contour of said building or parcel of land, presented by the contour-coordinate information as selected, or placed within an inside of said planar contour; and
determining, based on the house number as calculated, the house number, which is to be assigned to said contour-coordinate information as selected.

5. A non-transitory computer-readable recording medium storing a map information processing program, which causes a computer to function as:
a reading unit that reads first map data comprising road link information including house number range information indicative of a range of a house number and second map data comprising contour-coordinate information indicative of a group of coordinates by which planar contours of buildings or parcels of land are represented;
a selection unit that selects the contour-coordinate information corresponding to a single building or parcel of land of the buildings or parcels of land;
a road link specifying unit that specifies, based on the contour-coordinate information as selected, a nearest road link to the building or parcel of land corresponding to said contour-coordinate information;
a house number range information acquiring unit that acquires the house number range information of said road link information corresponding to the road link as specified;
a house number calculating unit that calculates, based on the house number range information as acquired, the house number of a point at an intersection of a perpendicular line drawn from a predetermined point to said road link as specified, with said road link, said predetermined point being placed on an outer edge of the planar contour of said building or parcel of land, presented by the contour-coordinate information as selected, or placed within an inside of said planar contour; and
a house number determining unit that determines, based on the house number as calculated, the house number, which is to be assigned to said contour-coordinate information as selected.

6. (canceled)
